(19) United States
(12) Patent Application Publication
(10) Pub. No.: US 2005/0109935 A1
(43) Pub. Date: May 26, 2005

(54) Sensor and method of transmitting data in multiple protocols

(76) Inventors: Gregory J. Manlove, Kokomo, IN (US); Mark R. Keyse, Sharpsville, IN (US); Robert K. Constable, Kokomo, IN (US)

Correspondence Address: STEFAN V. CHMIELEWSKI;DELPHI TECHNOLOGIES, INC., Legal Staff MC CT10C, P.O. Box 9005, Kokomo, IN, 46904-9005, US

(21) Appl. No.: 10/804,741

(22) Filed: Mar. 19, 2004

Related U.S. Application Data
(63) Continuation-in-part of application No. 10/697,550, filed on Oct. 30, 2003.

(51) Int. Cl. G01D 5/34

(52) U.S. Cl. 250/300

(57) ABSTRACT

A sensor and method are provided for sensing characteristics, such as pressure and temperature, and transmitting the sensed characteristics and stored data in first and second data communication protocols. The sensor includes stored data transmit in an output signal according to a first data communication protocol. The sensor senses pressure and temperature and transmits the sensed pressure and temperature characteristics in a pulse width modulated output signal according to a second data communication protocol. The stored data is transmit following a power reset, and subsequent thereto the sensed data is transmit.

### CROSS-REFERENCE TO RELATED APPLICATION

This application is a continuation-in-part of application Ser. No. 10/697,550, filed on Oct. 30, 2003, entitled “SENSOR AND METHOD OF TRANSMITTING SENSOR DATA,” the entire disclosure of which is hereby incorporated herein by reference.

### TECHNICAL FIELD

The present invention generally relates to sensors and, more particularly, relates to a sensor, such as a pressure sensor, and method for transmitting sensor data.

### BACKGROUND OF THE INVENTION

Pressure sensors and various other sensors are commonly employed in automotive vehicle applications to control and monitor various aspects of the vehicle operation. In particular, pressure sensors are commonly employed in passive occupant detection systems (PODS) which typically employ a fluid-filled bladder connected to the pressure sensor, a belt tension sensor, and an electronic control unit (ECU). The pressure sensor employed in a conventional PODS generally has a three-wire interface, providing supply, ground, and an output voltage. The output voltage generated with the conventional PODS pressure sensor is an analog signal typically operable to sense pressure in the range of about 0 to 2.5 pounds per square inch (psi).

Pressure sensors are generally required to provide an accurate analog voltage output representative of the pressure applied to a sensing element. In automotive applications, the pressure sensor is generally required to be accurate over a large temperature range of approximately −40° to +125° C. throughout the life of the vehicle. In order to compensate for temperature induced variations in the sensor signal, the pressure sensor is equipped with compensation circuitry for compensating gain and offset due to temperature variations.

In the conventional PODS, the ECU generally includes power conditioning circuitry for the pressure sensor and the belt tension sensor, a microprocessor that processes a classification algorithm, and a temperature sensor (thermistor) for temperature compensation of other system components. Additionally, the ECU typically includes serial communication circuitry to communicate passenger occupancy status to a sensing and diagnostic module. The pressure sensor also contains temperature compensation circuitry to correct the gain and offset due to temperature variations. The employment of multiple temperature sensors introduces redundancy and costs to an automotive vehicle. Additionally, the temperature sensors generally require additional electrical circuitry and/or pin configurations to receive the temperature information.

Accordingly, it is therefore desirable to provide for a sensor, such as a pressure sensor, that allows for easy compensation of gain and offset due to temperature variations. In particular, it is desirable to provide for a method of transmitting sensor data, such as pressure and temperature data, to control circuitry in a manner that minimizes circuitry and pin connections. It is further desirable to provide for a low cost sensor and method of transmitting sensed data and stored data, such as calibration data, from the sensor to another electronic device, such as an ECU.

### SUMMARY OF THE INVENTION

In accordance with the teachings of the present invention, a sensor and method are provided for transmitting sensor data in first and second data communication protocols. According to one aspect of the present invention, the sensor includes a sensing element for sensing a sensor characteristic, and memory for storing data relevant to the sensor. The sensor also includes output circuitry for outputting the sensor characteristic and the stored data in an output signal. The sensor further includes a controller for controlling the outputting of the sensor characteristic and the stored data. The sensor transmits the stored data in the output signal according to a first data communication protocol and transmits the sensor characteristic in the output signal according to a second data communication protocol.

According to another aspect of the present invention, the method includes the steps of sensing a sensor characteristic with a sensor and storing data in the sensor. The method also includes the step of generating an output signal. The method further includes the steps of transmitting the stored data in the output signal according to a first data communication protocol, and transmitting the sensor characteristic in the output signal according to a second data communication protocol.

Accordingly, the sensor and method of the present invention advantageously transmits one or more sensor characteristics and stored data in the sensor in multiple data communication protocols. According to a further aspect, the first data communication protocol includes a constant frequency and the second data communication protocol includes a pulse width modulated signal.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram illustrating a passive occupant detection system (PODS) employing an analog pressure sensor communicating pressure and temperature characteristics according to the present invention;

FIG. 2 is a circuit diagram illustrating the analog pressure sensor;

FIG. 3 is a circuit diagram illustrating a V_{RAMP} generator used for generating a pulse width modulated output signal in the sensor;

FIG. 4 is a circuit diagram illustrating a current sourcing circuit for use in the V_{RAMP} generator circuit;

FIG. 5 is a graph illustrating a pulse width modulated output signal generated with the sensor according to the present invention;

FIG. 6 is a graph illustrating a portion of the variable frequency with temperature ramp voltage V_{RAMP} shown in FIG. 5;

FIG. 7 is a flow diagram illustrating a method of communicating data in two different protocols beginning at power reset; and

FIG. 8 is a graph illustrating data communication according to a universal synchronous asynchronous receiver transmitter (UART) protocol, according to one embodiment.

### DESCRIPTION OF THE PREFERRED EMBODIMENT

A sensor is shown and described herein as a pressure sensor, according to one embodiment, for sensing pressure in a passive occupant detection system (PODS) in a vehicle. The sensor initially transmits stored data in an output signal according to a first data communication protocol following a power reset, and then subsequently communicates the sensed data in the output signal according to a different second data communication protocol. In the first data communication protocol, stored data, such as calibration data including vehicle make and model year, seat calibrations for use in a passive occupant detection system algorithm, and other data, are transmitted at a constant frequency from the sensor to another electronic device.

In the second data communication protocol, the sensor transmits the sensed pressure characteristic and a temperature characteristic in a pulse width modulated output signal from the sensor to another electronic device.

In the embodiment shown and described herein, the sensor transmits two characteristics, namely pressure and temperature, in a single pulse width modulated output signal. This is achieved, in the embodiment shown, by transmitting the pressure characteristic as a function of pulse width, such as the duty cycle, of the pulse width modulated output signal, and simultaneously transmitting the temperature characteristic as a function of frequency of the pulse width modulated output signal. While temperature and pressure are shown and described herein for transmitting in the pulse width modulated output signal, it should be appreciated that any two sensor characteristics may be transmitted in the pulse width modulated output signal. The sensor shown and described herein is not intended to be limited to the specific disclosed embodiment.

Referring to FIG. 1, a passive occupant detection system PODS) 10 is generally shown including a fluid-filled bladder 12 of a conventional type, such as may be employed in the seat of an automotive passenger vehicle to detect an occupant in the vehicle seat. An analog pressure sensor 20 is employed for sensing pressure of the fluid-filled bladder 12. The analog pressure sensor 20 may employ any of a number of pressure sensing elements such as piezo-resistive elements and variable capacitance type sensors.

The PODS 10 also includes a sensing and diagnostic module (SDM) 14 for performing sensing, diagnostics, and other processing of the PODS 10 including receipt and processing of the output signal generated by the analog pressure sensor 20. A data bus 16 is provided for communicating data between the analog pressure sensor 20 and the sensing and diagnostic module 14. One example of the data bus 16 includes a two-wire current modulated data bus. However, other single or multiple wire data buses may be employed.

The data communicated on data bus 16 includes the stored data (e.g., calibration data) transmitted immediately following a power reset. The data communicated on data bus 16 also includes the sensor sensed characteristics (e.g., pressure and temperature characteristics) transmitted via a pulse width modulated signal according to the second data communication protocol as described herein. The first and second data communication protocols are different in that the first data communication protocol is transmitted at a constant frequency, whereas the second data communication protocol has a variable frequency that varies as a function of the sensed temperature characteristic, according to one embodiment.

The sensing and diagnostic module 14 also receives a seat belt pretension signal 18. The seat belt pretension signal 18 may be generated with a seat belt pretensioner sensor and is indicative of the pretensioning condition of the seat belt.

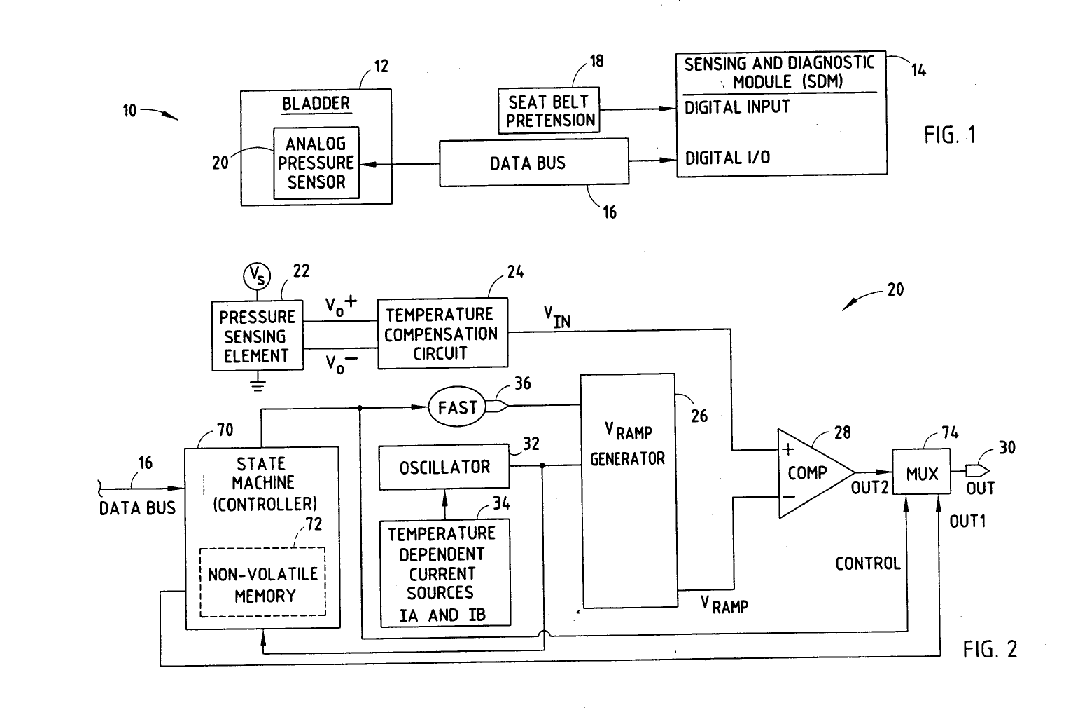

Referring to FIG. 2, the analog pressure sensor 20 is shown including a pressure sensing element 22 coupled to a supply voltage V_{S} and ground. The pressure sensing element 22 may include a piezo-resistive sensor having four resistors configured in a Wheatestone Bridge, according to one example, in which the resistors change in proportion to applied pressure to generate a differential output voltage Vₒ+minus Vₒ−. The differential output voltage Vₒ+minus Vₒ− is supplied to a temperature compensation circuit 24 which may include a separate integrated circuit (IC) or may be integrated with the pressure sensing element 22 or other circuitry.

The temperature compensation circuit 24 may include conventional compensation circuitry for compensating for sensor offsets at room temperature and temperature dependent sensor offsets. This may be achieved by controlling one or more current sources via a programmed function, such as a lookup table. The one or more current sources generate an electrical current that is dependent upon the temperature of the environment.

Additionally, the temperature compensation circuit 24 may include a voltage-to-current converter for converting the differential voltage to a current signal, and a multiplier for compensating for room temperature and temperature dependent gain. The temperature compensation circuit 24 generates an analog voltage V_{IN} indicative of the gain and offset compensated pressure. The voltage V_{IN} is applied to a non-inverting input of comparator 28.

The analog pressure sensor 20 also includes a ramp voltage V_{RAMP} generator 26 for generating a ramp voltage signal V_{RAMP.} The ramp voltage V_{RAMP} is applied to the inverting input (−) of comparator 28. The V_{RAMP} generator generates the ramp voltage V_{RAMP} in response to an input from an oscillator 32. The oscillator 32 generates an oscillation signal as a function of temperature via temperature dependent current sources I_{A} and I_{B}. Accordingly, the oscillator 32 generates a ramp voltage V_{RAMP} having a frequency that is dependent on temperature.

The comparator 28 compares the analog voltage V_{IN} to the ramp voltage V_{RAMP} and generates an output signal OUT2 at its output. The output signal OUT2 is a pulse width modulated output signal that transmits (communicates) the sensed pressure characteristic as a function of the pulse width, and more particularly as a function of the duty cycle, of the pulse width modulated output signal. Additionally, the output signal OUT2 transmits the sensed temperature characteristic as a function of the frequency of the pulse width modulated output signal. Accordingly, both pressure and temperature characteristics are transmitted in a single pulse width modulated output signal according to the second data communication protocol. The duty cycle of the pulse width modulated output signal is defined as the pulse width of the signal divided by the period of the signal. With the temperature characteristic transmitted as a function of frequency of the output signal, the pressure characteristic in the duty cycle is unaffected since it is a ratio of the pulse width to the period.

The analog pressure sensor 20 is further shown including a controller, shown and described herein as a state machine 70, coupled to the data bus 16. The controller 70 may include any of a number of analog and/or digital controllers, preferably having non-volatile memory 72 for storing data, such as calibration data. As an alternative, a microprocessor-based controller could be employed in place of the state machine 70. The state machine 70 functions as a controller to store calibration data, such as vehicle make and model year, seat calibrations for use in a passive occupant detection system algorithm, and other data that may be useful for service technicians. The calibration data may be stored in memory in the state machine and is relevant to the analog pressure sensor 20 and its use in a vehicle.

The state machine 70 performs control logic to generate a FAST signal on input 36 to V_{RAMP} generator 26. The state machine 70 generates the FAST signal in response to detecting a power reset to initiate data communication in the first data communication protocol to transmit the stored calibration data stored in non-volatile memory 72 to the sensing and diagnostic module 14. The FAST signal is applied for a predetermined time period (e.g., about 500 milliseconds) in an initialization mode following a power reset. Application of the FAST signal on input 36 of V_{RAMP} generator 26 generates a constant frequency oscillation signal.

Additionally, the state machine 70 generates an output signal OUT1 applied to multiplexer 74. Output signal OUT1 has a constant frequency signal transmitting the stored calibration data to be supplied to output 30 for transmission to the sensing and diagnostic module 14 when the FAST signal is applied during the initialization mode. The multiplexer 74 may include a 2-input/1-control line multiplexer that receives the FAST signal output from state machine 70 as the control signal and selects one of the signals OUT2 and OUT1 as the output signal OUT based on the binary state of the FAST signal. More particularly, multiplexer 74 passes output signal OUT2 to output 30 as the output signal OUT when the FAST signal is set to binary zero. When FAST signal is set to binary one, the multiplexer 74 passes output signal OUT1 to output 30 as output signal OUT. This causes the stored calibration data in the sensor 20 to be transmitted to SDM 14 so that accurate calibration is employed by the passive occupant detection system. Accordingly, the multiplexer 74 is controlled by the state machine 70 to transmit sensed and stored data in output signal OUT according to first and second data communication protocols.

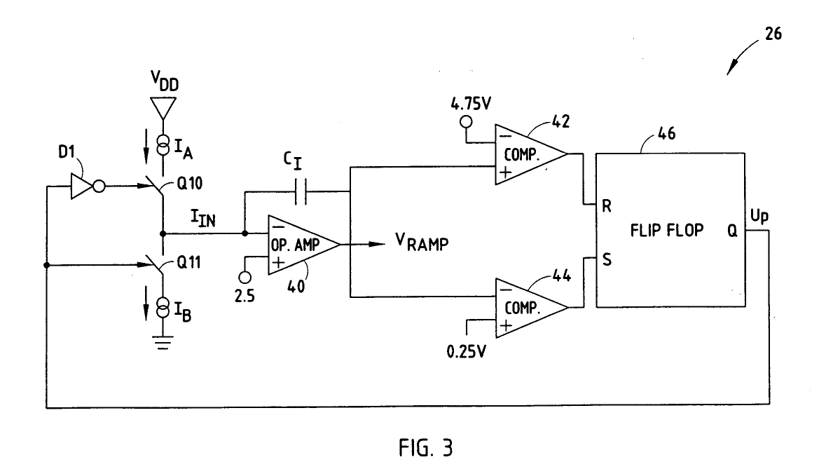

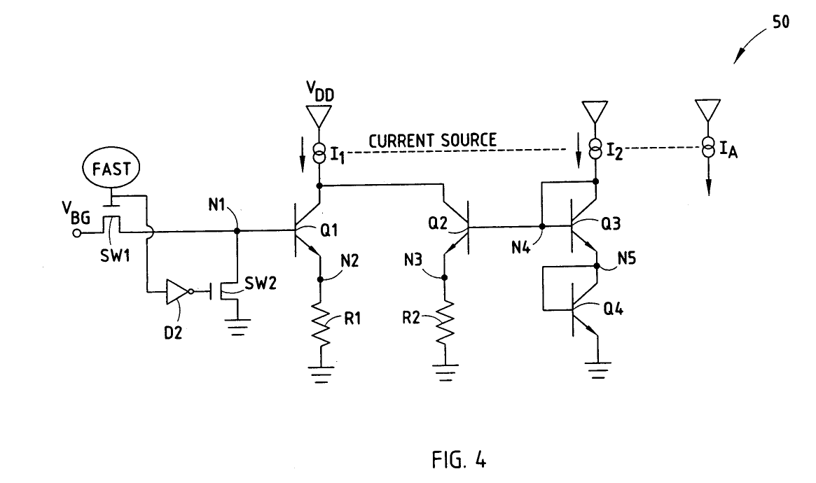

Referring to FIG. 3, the V_{RAMP} generator 26 is illustrated in a circuit diagram having a first current source I_{A} coupled to the voltage supply V_{DD}, and also having a second current source I_{B} coupled to ground. The first and second current sources I_{A} and I_{B} generate electrical current as a function of the environmental temperature, and hence operate as temperature sensing circuitry. While current sources I_{A} and I_{B} are shown configured coupled to a supply voltage V_{DD} and ground, it should be appreciated that other temperature sensing circuitry may be employed to sense temperature, without departing from the teachings of the present invention.

The V_{RAMP} generator 26 includes a pair of transistors Q10 and Q11 coupled between current sources I_{A} and I_{B}. The junction between transistors Q10 and Q11 is coupled to an inverting input (−) of an op amp 40. The non-inverting input (+) of op amp 40 is coupled to a voltage supply of 2.5 volts. A capacitor C₁ is coupled across op amp 40. The op amp 40 generates the ramp voltage V_{RAMP} as its output.

Additionally, the V_{RAMP} generator 26 includes a pair of comparators 42 and 44 and a flip-flop 46. The first comparator 42 compares the ramp voltage V_{RAMP} to an upper voltage of about 4.75 volts, while the second comparator compares the ramp voltage V_{RAMP} to a lower voltage of about 0.25 volts. The outputs of comparators 42 and 44 are supplied to inputs reset R and set S, respectively, of RS flip-flop 46. Flip-flop 46 generates, at its output Q, a binary an output signal UP which in turn is applied to control transistors Q10 and Q11.

The V_{RAMP} generator 26 operates as follows. Initially, assuming the ramp voltage V_{RAMP} is low, the flip-flop output labeled UP is asserted and the second current source I_{B} is switched into the inverting (−) input terminal of op amp 40. The inverting (−) terminal is a virtual ground and all of the current is applied to capacitor C₁. The ramp voltage V_{RAMP} begins to rise at a frequency (f) defined by the following equation:
frequency (f)=I/C×(ΔV),
where I equals the input current I_{B}, C is the integrator capacitor C₁, and ΔV is the voltage range of the comparator voltage 4.75 volts minus 0.25 volts, which equals 4.5 volts. The ramp voltage V_{RAMP} continues to increase in magnitude until it is greater than 4.75 volts and, at that point, the output of the first comparator 42 is asserted and the reset input R to the RS flip-flop 46 is asserted and its output Q goes low. This, in turn, turns off the second current source I_{B} and turns on the first current source I_{A}. The first current source I_{A} equals the second current source I_{B} and causes the integrator to ramp down at the same frequency set forth in the above equation. The ramp voltage V_{RAMP} continues to ramp down until its voltage is less than 0.25 volts. At that time, the second comparator 44 is asserted and the set input S on RS flip-flop 46 is asserted such that its output Q causes signal UP to be high, thereby starting the process again.

It should be appreciated that the ramp voltage V_{RAMP} continues to oscillate at the frequency described in accordance with the above equation. The frequency is directly proportional to the first and second current sources I_{A} and I_{B}, which are set equal to one another, according to the embodiment shown herein.

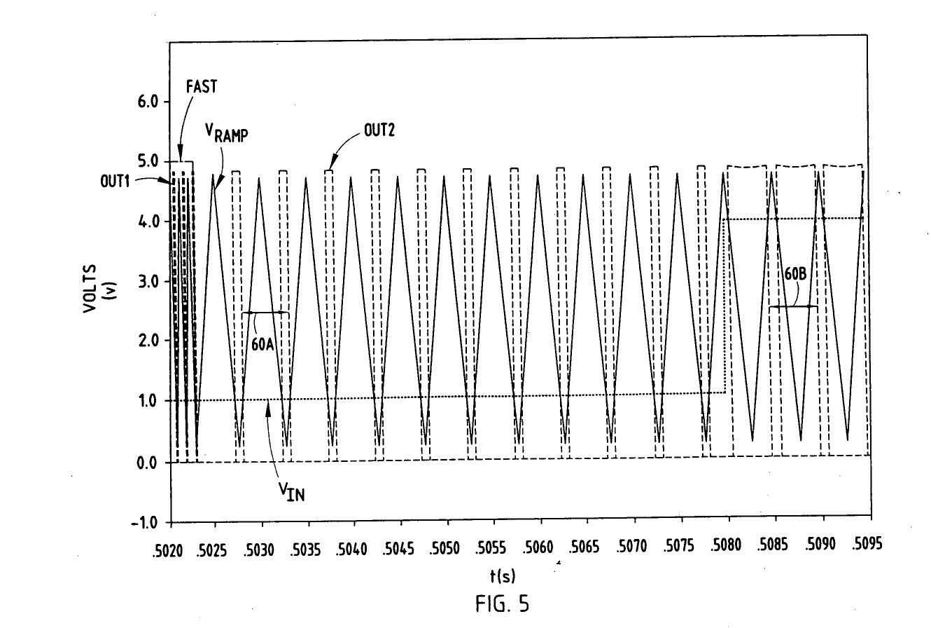

Referring to FIG. 4, the first current source I_{A} is shown generated by a current mirror 50 coupled to a voltage supply V_{DD}. Current mirror 50 generates a negative temperature coefficient (TC) current source that is achieved with transistors Q2, Q3, Q4, and resistor R2. The voltage at node N3 is equal to voltage V_{be} on an NPN transistor (V_{be3}+V_{be4}−V_{be2}) where V_{be2} and V_{be3} are essentially equal because the current through the collectors are essentially the same. Voltage V_{be} has a negative temperature dependency of approximately 2 millivolts per degree Celsius, according to one embodiment. The resistor R2 has a positive temperature coefficient of 1,500 ppm. The reduction in voltage and increase in resistance combine to generate a current that reduces with temperature in a consistent manner such that the current source I_{A} is generated as a function of the temperature, and thus varies as a function of temperature.

The output of the current source is equal to current I₁ and is applied as a current mirror to generate current I₂ and current source I_{A}. Current source I_{A} is the current used in the V_{RAMP} generator circuit 26. An additional current mirror is used to generate the second current source I_{B}, such that current sources I_{A} and I_{B} are the same. The second current source I_{B} is generated similar to the first current source I_{A}, except the second current source I_{B} is coupled to ground, rather than the supply voltage.

The current mirror 50 includes switches SW1 and SW2 and receives digital control signal labeled FAST to generate a constant current regardless of temperature. The fast signal is used to produce a desired output frequency that is constant at startup (initialization mode following a power reset) to provide for data communication in the first data communication protocol. Following the initialization mode, the FAST signal is set equal to zero to transmit sensor characteristic data (e.g., pressure and temperature) in the second data communication protocol in which the frequency varies in proportion to the temperature following the startup mode.

Upon detecting a power reset during startup, the FAST signal is asserted, and switch SW1 is switched on and switch SW2 is switched off. The voltage at node N1 moves from ground to voltage V_{bg}. Voltage V_{bg} is the band gap voltage and is approximately equal to 1.25 volts, according to one example. The band gap voltage V_{bg} is generated in an on-chip regulator circuit, according to one embodiment. The voltage at node N2 is equal to voltage V_{bg} minus V_{be1}. Because V_{be} has a minus two (−2) millivolt per degree Celsius (−2 mV/° C.) slope, the voltage on node N2 increases at a rate of two millivolt per degree Celsius (2 mV/° C.), thus producing a positive temperature coefficient (TC) current source. The collectors of transistors Q1 and Q2 are connected together and are applied to current mirror I₁. The resistor R1 and R2 are established such that the resultant current source I₁, equal to the sum of the negative and positive temperature coefficient current sources, has a zero temperature coefficient output. This generates a current that does not change with temperature.

The output of ramp voltage V_{RAMP} is a triangular waveform with a fifty percent (50%) duty cycle that is controlled by the current sources I_{A} and I_{B}, as shown in FIG. 5. When the FAST input is asserted for a time period of about 500 milliseconds during startup following a power reset, as shown at the beginning of the waveform seen in FIG. 5, the current source has zero temperature coefficient and the output frequency is constant. During this period of time, a conventional universal asynchronous receiver transmitter (UART) protocol is used to transmit stored data in an output signal OUT1 according to the first data communication protocol for communication during this startup initialization mode, and various types of stored parameters can be set. Examples of stored data parameters include calibration data such as vehicle make and model year, seat calibrations for use in one or more PODS algorithms, security data, and data useful to service technicians. The calibration data is transmitted from the sensor 20 to the sensing and diagnostic module 14 following a power reset such that the sensing and diagnostic module 14 is updated with calibration data relevant to the sensor 20 and its use in the vehicle. For a UART or any other conventional bus, an accurate known frequency is employed. In the present application employing UART, the first data communication protocol has a known constant frequency of 9.6 kHz and is available the first approximately 500 milliseconds after power up, according to one example.

When the FAST input is deasserted, data communication is provided in the second data communication protocol in which the current source has a known negative temperature coefficient producing a frequency that is inversely proportional to temperature. The resultant output signal labeled OUT2 is a pulse width modulated output signal having its duty cycle determined by the pressure output signal V_{IN}. As the pressure sensed output V_{IN} changes, the duty cycle of PWM signal OUT2 likewise changes.

In the example illustrated in FIG. 5, the analog sensed output V_{IN} generated by the sensing element is initially at 1.0 volt. The analog voltage V_{IN} is then increased to 4.0 volts at about 8 milliseconds. The duty cycle of the pulse width modulated output signal OUT2 increases for every change in analog voltage V_{IN}. The pulse width modulated output signal OUT2 can then be processed to monitor for variations, regardless of any timing uncertainty of a microprocessor. The faster the clock, the more accurate the evaluation of the duty cycle and frequency. Thus, the resolution of the sensor and its transmitted signal is controlled by clock rate of the microprocessor in a receiving device that processes that pulse width modulated output signal OUT2.

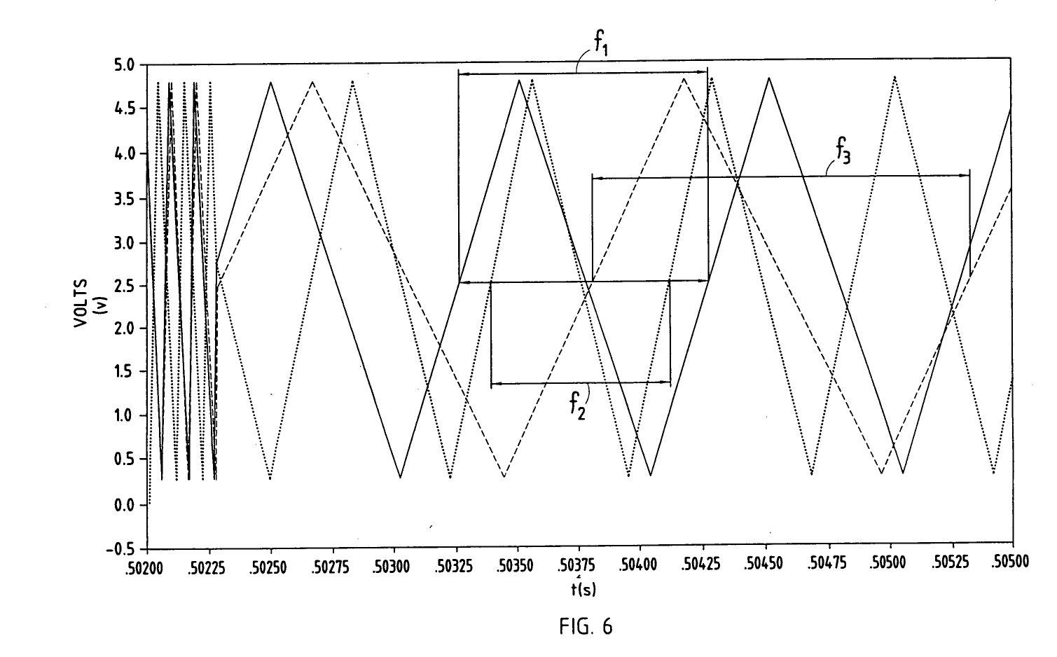

Referring to FIG. 6, the ramp voltage V_{RAMP} is illustrated in a simulation at three different temperature, such as 90° C., 25° C., and −40° C., according to one example. The ramp voltage V_{RAMP} for each temperature is shown simulated to show that the frequencies f3, f1, and f2, of the corresponding signals, exhibit a large temperature dependency. When the integrated circuit is at a temperature of 90° C., the ramp voltage V_{RAMP} has a frequency of approximately 659 Hz. At room temperature, the ramp voltage V_{RAMP} has a frequency of approximately 990 Hz. At a temperature of −40° C., the ramp voltage V_{RAMP} has a frequency of approximately 1371 Hz. This produces a temperature dependent frequency for transmitting the temperature characteristic in the pulse width modulated output signal according to the present invention. In addition, all the clock frequencies are 9.6 kHz, regardless of temperature at startup. This is caused by asserting the FAST signal high. During this initialization time, communication of the stored data occurs.

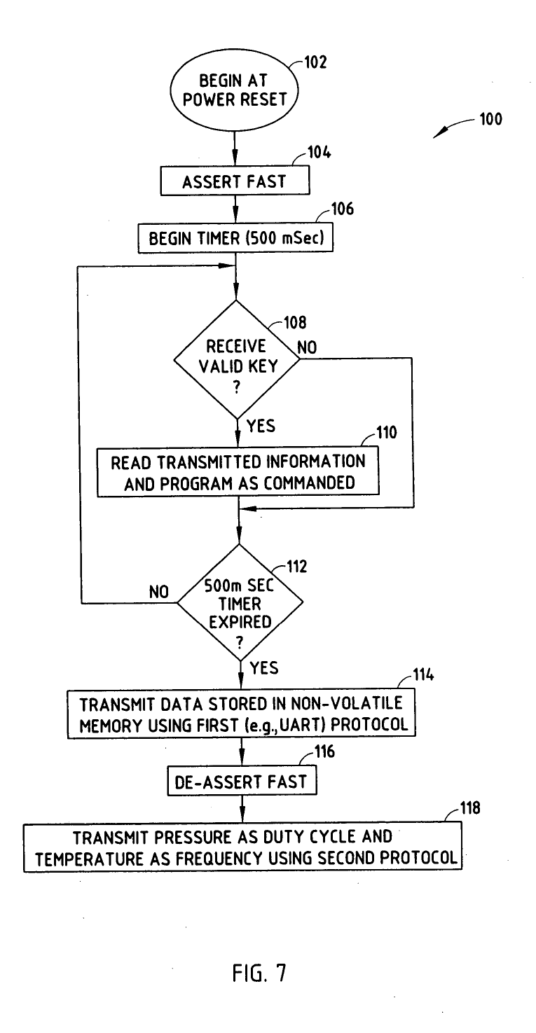

The sensor 20 according to the present invention advantageously transmits data in output signals according to multiple data communication protocols, including the first and second data communication protocols. Referring to FIG. 7, the transmission of data from the sensor 20 is illustrated by method 100, according to one embodiment. Method 100 begins in the initialization mode at a power reset as shown in block 102. In block 104, the FAST signal is asserted (e.g., FAST equals binary one (high)), and a timer begins in step 106. The timer is approximately a 500 millisecond timer, according to one example, which defines the time period of the initialization mode.

Method 100 proceeds to decision step 108 to determine if a valid key has been received. The valid key may include a hard coded sequence of binary bits provided in the integrated circuitry (e.g., ASIC). If a valid key has not been received, transmitted information is not read. If a valid key has been received, method 100 proceeds to step 110 to read transmitted information and program as commanded. This includes reading stored data, such as calibration data, stored in non-volatile memory 72 within the sensor 20. In decision step 112, method 100 checks for whether the timer has expired and, if not, repeats step 108 through 112.

Once the timer has expired, the initialization mode is nearly complete and method 100 proceeds to transmit the data stored in the non-volatile memory 72 of sensor 20 according to the first data communication protocol in step 114. According to the embodiment shown and described herein, the first data of communication protocol may include the UART protocol. Once the stored data is transmitted, method 100 proceeds to deassert (set FAST to low (zero)) the FAST signal in step 116. This concludes the transmission of data in the first data communication protocol following a power reset.

Following completion of the 500 millisecond start-up initialization mode, method 100 proceeds to step 118 to transmit the sensed pressure characteristic as a duty cycle and the temperature characteristic as frequency according to the second data communication protocol. The sensed pressure and temperature data continues to be transmitted according to the second data communication protocol until power is no longer supplied to the sensor 20. Accordingly, method 100 is repeated each time a power reset occurs.

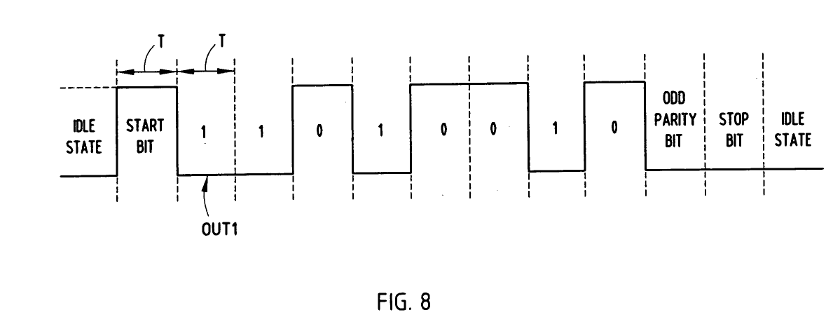

Referring to FIG. 8, an output signal OUT1 is illustrated transmitting a series of binary data according to a UART data communication protocol as one example as the first data communication protocol. The UART protocol is a conventional constant frequency data transmission in which address and stored data are transmitted as a series of binary bits. According to one example, the stored calibration data is stored in a plurality of words, such as eight words, and may include an additional ninth word to provide an indication of age of the data. While a UART protocol is illustrated for use as the first data communication protocol, it should be appreciated that other data communication protocols may be employed in accordance with the present invention. Additionally, it should be appreciated that while first and second data communication protocols are illustrated herein, any two or more data communication protocols may be employed to transmit data to or from the sensor 20 in accordance with the teachings of the present invention.

The sensor pressure and temperature characteristics are advantageously transmitted simultaneously in a pulse width modulated output signal according to the second data communication protocol without requiring large amounts of additionally circuitry and connecting pins. This advantageously eliminates the need for a separate temperature sensor, such as may be found in the electronic control unit of a passenger occupant detection system, thus resulting in cost savings. Additionally, the resolution of the data is determined by the clock rate of a microprocessor in the passenger occupant detection system electronic control unit. Higher clock rates correlate to more resolution. This allows for enhanced system performance without a modification to the passive occupant detection system unit, since microprocessors generally have a timer control system, and thus, the circuit interface does not require specialized circuitry. If a fault in the passive occupant detection system is detected, such as a wire is broken according to one example, the output signal OUT can be held low such that the SDM 14 recognizes this as a fault condition.

Further, the sensor 20 and method 100 of the present invention advantageously provides a low cost approach to transmitting stored calibration data and sensed data characteristics in an output signal that employs a plurality of data communication protocols. Thus, the stored system information can be transmit from the sensor 20 to the SDM 14 prior to communicating the sensed pressure and temperature characteristics, without requiring additional costly circuitry.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. a sensor comprising:
a sensing element for sensing a sensor characteristic;
memory for storing data relevant to the sensor;
output circuitry for outputting the sensor characteristic and the stored data in an output signal; and
a controller for controlling the outputting of the sensor characteristic and stored data, said controller transmitting the stored data in the output signal according to a first data communication protocol and transmitting the sensor characteristic in the output signal according to a second data communication protocol.

2. The sensor as defined in claim 1, wherein the stored data is transmitted in the first data communication protocol following a power reset.

3. The sensor as defined in claim 2, wherein the stored data is transmitted during a predetermined time period.

4. The sensor as defined in claim 1, wherein the stored data comprises calibration data.

5. The sensor as defined in claim 1, wherein said sensor further comprises temperature sensing circuitry for sensing a temperature characteristic, wherein the sensor characteristic and temperature characteristic are transmitted in the output signal according to the second data communication protocol as a pulse width modulated output signal containing an indication of the sensor characteristic, wherein one of the sensor and temperature characteristics is transmitted as a function of pulse width of the pulse width modulated output signal, and the other of the sensor and temperature characteristics is transmitted as a function of frequency of the pulse width modulated output signal.

6. The sensor as defined in claim 5, wherein the one of the sensor and temperature characteristics is transmitted as a function of duty cycle of the pulse width modulated signal.

7. The sensor as defined in claim 1, wherein the sensing element comprises a pressure sensor.

8. The sensor as defined in claim 7, wherein the pressure sensor is coupled to a fluid-filled bladder for sensing an occupant in a vehicle.

9. A sensor as defined in claim 1, wherein the output signal according to the first data communication protocol includes a constant frequency signal.

10. A method of transmitting sensor generated output data and stored data in an output signal according to first and second data communication protocols, said method comprising the steps of:
sensing a sensor characteristic with a sensor;
storing data in the sensor;
generating an output signal;
transmitting the stored data in the output signal according to a first data communication protocol; and
transmitting the sensor characteristic in the output signal according to a second data communication protocol.

11. The method as defined in claim 10 further comprising the step of detecting a power reset, wherein the stored data is transmit following a power reset, and the sensor characteristic is transmit following transmission of the stored data.

12. The method as defined in claim 10, wherein the sensor characteristic is transmitted following a predetermined time.

13. The method as defined in claim 10 further comprising the step of sensing a temperature characteristic, wherein the sensor and temperature characteristics are transmitted in a pulse width modulated output signal containing the sensor characteristic as a function of pulse width of the pulse width modulated output signal and the temperature characteristic as a function of the frequency of the pulse width modulated output signal.

14. The method as defined in claim 10, wherein the first data communication protocol comprises a constant frequency, and the second data communication protocol comprises a variable frequency.

15. The method as defined in claim 14, wherein the frequency of the second data communication protocol varies as a function of temperature.

16. The method as defined in claim 10 further comprising the step of transmitting the stored and sensor data to a control device for use in a vehicle.

17. The method as defined in claim 16 further comprising the step of processing the stored and sensor data to detect presence of an occupant in the vehicle.

18. The method as defined in claim 10, wherein the step of storing data in the sensor comprises storing calibration data relevant to the sensor.
